(19) United States
(12) Patent Application Publication
(10) Pub. No.: US 2021/0055420 A1
(43) Pub. Date: Feb. 25, 2021

(54) BASE FOR SPHERICAL LASER SCANNER AND METHOD FOR THREE-DIMENSIONAL MEASUREMENT OF AN AREA

(71) Applicant: FARO Technologies, Inc., Lake Mary, FL (US)

(72) Inventors: Denis Wohlfeld, Ludwigsburg (DE); Matthias Wolke, Korntal-Münchingen (DE)

(21) Appl. No.: 16/990,590

(22) Filed: Aug. 11, 2020

Related U.S. Application Data
(60) Provisional application No. 62/889,219, filed on Aug. 20, 2019.

(51) Int. Cl. G01S 17/894; G06T 19/20; G06T 7/90; H04N 5/247; H04N 9/09; H04N 5/225; H04N 5/232; G06T 7/55; G01C 11/02

(52) U.S. Cl. CPC G01S 17/894; G06T 2207/10016; G06T 7/90; H04N 5/247; H04N 9/09; H04N 5/2253; H04N 5/23245; H04N 5/23299; G06T 7/55; G01C 11/025; G06T 2207/10028; G06T 2207/20084; G06T 2219/2012; G06T 2207/10024; G06T 19/20

(57) ABSTRACT

A three-dimensional (3D) measuring device may include a spherical laser scanner (SLS) structured to generate a 3D point cloud of an area; a plurality of cameras, each camera of the plurality of cameras being structured to capture a color photographic image; a controller operably coupled to the SLS and the camera; and a base on which the SLS is mounted. The controller may include a processor and a memory. The controller may be configured to add color data to the 3D point cloud based on the color photographic images captured by the plurality of cameras. The plurality of cameras may be provided on the base and spaced apart in a circumferential direction around a pan axis of the SLS. The plurality of cameras may be fixed relative to the pan axis.

### CROSS REFERENCE TO RELATED APPLICATIONS

This application claims the benefit of U.S. Provisional Application Ser. No. 62/889,219 filed Aug. 20, 2019, the entire disclosure of which is incorporated herein by reference.

### BACKGROUND

The subject matter disclosed herein relates to a laser scanner and in particular to a laser scanner able to acquire and display multiple parameters related to a scanned object.

Laser scanners are a type of device that utilize a light source to measure and determine the three-dimensional coordinates of points on the surface of an object. Laser scanners are typically used for scanning closed or open spaces such as interior areas of buildings, industrial installations and tunnels. Laser scanners are used for many purposes, including industrial applications and accident reconstruction applications. A laser scanner can be used to optically scan and measure objects in a volume around the scanner through the acquisition of data points representing objects within the volume. Such data points are obtained by transmitting a beam of light onto the objects and collecting the reflected or scattered light to determine the distance, two-angles (i.e. an azimuth and a zenith angle), and optionally a gray-scale value. This raw scan data is collected, stored and sent to a processor or processors to generate a three-dimensional image representing the scanned area or object. In order to generate the image, at least three values are collected for each data point. These three values may include the distance and two angles, or may be transformed values, such as the x, y, z coordinates.

One type of laser scanner is a laser scanner (LS) that can scan a nearly complete spherical volume in a short period of time. By moving an LS through a scan area, an accurate 3D point cloud may be captured, no color data or spherical image is recorded.

A laser scanner may also include a camera mounted on or integrated into the laser scanner for gathering camera digital images of the environment. In addition, the camera digital images may be transmitted to a processor to add color to the scanner image. In order to generate a color scanner image, at least six values (three-positional values such as x, y, z; and color values, such as red, green and blue values or “RGB”) are collected for each data point.

Accordingly, while existing laser scanners are suitable for their intended purposes, what is needed is a laser scanner that has certain features of embodiments of the present invention.

### BRIEF SUMMARY

According to an exemplary embodiment, a three-dimensional (3D) measuring device may include a spherical laser scanner (SLS) structured to generate a 3D point cloud of an area; a plurality of cameras, each camera of the plurality of cameras being structured to capture a color photographic image; a controller operably coupled to the SLS and the camera; and a base on which the SLS is mounted. The controller may include a processor and a memory. The controller may be configured to add color data to the 3D point cloud based on the color photographic images captured by the plurality of cameras. The plurality of cameras may be provided on the base and spaced apart in a circumferential direction around a pan axis of the SLS. The plurality of cameras may be fixed relative to the pan axis.

According to an exemplary embodiment, a base for use with a spherical laser scanner (SLS) structured to generate a 3D point cloud may include a base body structured to mount the spherical laser scanner; a plurality of cameras mounted on base body spaced in a circumferential direction around a pan axis of the SLS, each of the plurality of cameras being structured to capture a color photographic image; a controller operably coupled to the SLS and the plurality of cameras. The controller may include a processor and a memory. The controller may be configured to add color data to the 3D point cloud based on color photographic images captured by the plurality of cameras.

According to an exemplary embodiment, a method for measuring three-dimensional (3D) data of an area, the method may include generating, with a spherical laser scanner (SLS), a 3D point cloud of an area; capturing, with a plurality of cameras, color photographic images of the area; and adding color data to the 3D point cloud based on the color photographic images. The plurality of cameras may be mounted on the base and spaced apart in a circumferential direction around a pan axis of the SLS.

Accordingly to an exemplary embodiment, a method for measuring three-dimensional (3D) data of an area may include providing a spherical laser scanner (SLS) and a camera mounted on a moveable carrier; moving the carrier along a movement path within the area; while the carrier is being moved along the movement path, generating, with the SLS, a 3D point cloud of the area; capturing, with the camera, a plurality of color photographic images at a predetermined distance interval along the movement path; and adding color data to each of the 3D point clouds based on the plurality of color photographic images.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a scanning device according to an exemplary embodiment;

FIG. 2 is a side view of a scanning device according to an exemplary embodiment;

FIG. 3 is a side view of a scanning device according to an exemplary embodiment;

FIG. 4 is a perspective view of a scanning device according to an exemplary embodiment;

FIG. 5 is a side view of a scanning device according to an exemplary embodiment;

FIG. 6 is a perspective view of a scanning device according to an exemplary embodiment;

FIG. 7 is a rear view of a scanning device according to an exemplary embodiment;

FIG. 8 is a side view of a scanning device according to an exemplary embodiment;

FIG. 9 is a front view of a scanning device according to an exemplary embodiment;

FIG. 10 is a top view of a scanning device according to an exemplary embodiment;

FIG. 11 is a perspective view of a scanning device according to an exemplary embodiment

FIG. 12 is a perspective view of a scanning device according to an exemplary embodiment;

FIG. 13 is a perspective view of a scanning device according to an exemplary embodiment;

FIG. 14 is a side view of a scanning device according to an exemplary embodiment;

FIG. 15 is a front view of a scanning device according to an exemplary embodiment;

FIG. 16 is a perspective view of a scanning device according to an exemplary embodiment;

FIG. 17 is a perspective view of a scanning device according to an exemplary embodiment;

FIG. 18 is a side view of a base for a scanning device according to an exemplary embodiment;

FIG. 19 is a rear view of a base for a scanning device according to an exemplary embodiment;

FIG. 20 is a rear view of a base for a scanning device according to an exemplary embodiment;

FIG. 21 is a perspective view of a base for a scanning device according to an exemplary embodiment;

FIG. 22 is a perspective view of a base for a scanning device according to an exemplary embodiment;

FIG. 23 is a schematic view of a scanning device according to an exemplary embodiment;

FIG. 24 is a perspective view of a base for a scanning device according to an exemplary embodiment;

FIG. 25 is a side view illustrating movement of a scanning device according to an exemplary embodiment;

FIG. 26 is flow chart illustrating a method for acquiring a 3D scan of an area;

FIG. 27 is flow chart illustrating a method for acquiring a 3D scan of an area; and

FIG. 28 is flow chart illustrating a method for acquiring a 3D scan of an area.

FIG. 29 is a flow chart illustrating a method for acquiring a 3D scan of an area.

The detailed description explains embodiments of the invention, together with advantages and features, by way of example with reference to the drawings.

### DETAILED DESCRIPTION

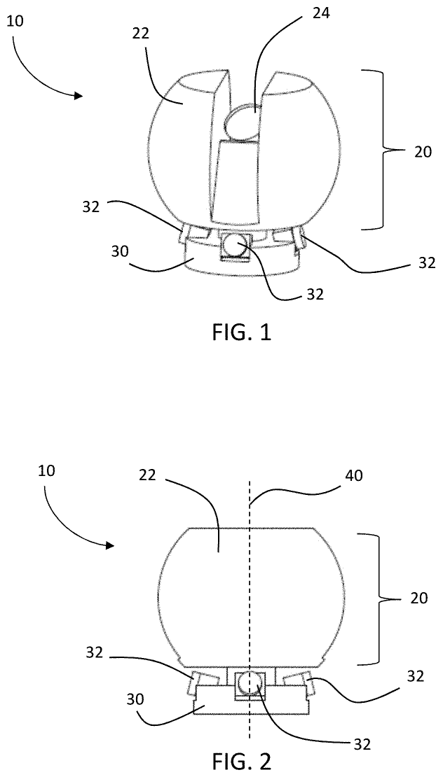

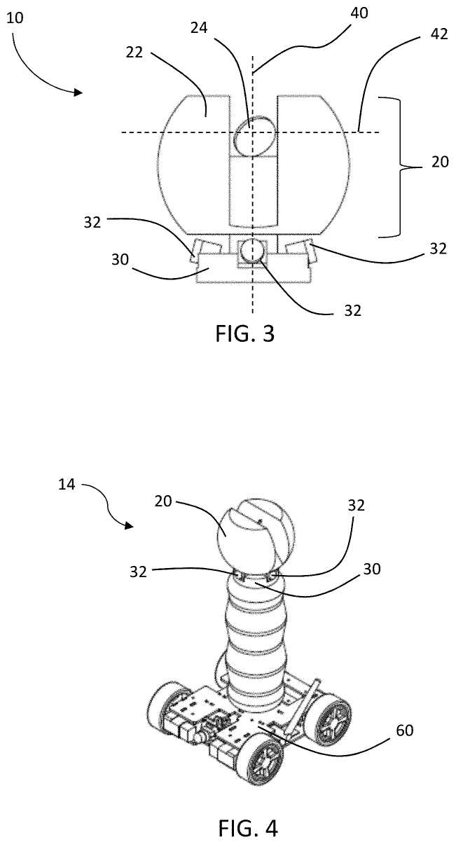

FIGS. 1-3 and FIG. 23 illustrate an exemplary embodiment of a three-dimensional (3D) measuring device 10. The scanning device 10 may include a spherical laser scanner (SLS) 20 and a base 30.

Laser scanning devices, such as SLS 20, for example, are used to acquire data for the geometry such as surfaces within an environment. These devices use a coherent light source to optically scan the environment and receive reflected beams of light. By knowing the direction and orientation of a beam of light in the amount time it takes to transmit and receive the light beam, the scanning device can determine the 3D coordinates of the surface point from which the light reflected. A controller operably coupled to SLS 20 can aggregate the 3D coordinates from a plurality of surface points into a 3D point cloud of the area being scanned. It should be appreciated that while embodiments herein may refer to the light emitted by the scanner as a “laser”, is this for example purposes and the claims should not be so limited. In other embodiments, the light may be generated by another light source, such as but not limited to superluminescent light emitting diodes (LED's)

SLS 20 may include a scanner body 22 and a mirror 24 structured to steer light emitted from the coherent light source. SLS 20 may further include a motor that rotates the scanner body 22 around an azimuthal or pan axis 40. In the illustrated embodiment, the body 22 has a spherical or semi-spherical shape that allows the rotation of the body 22 about the axis 40 while providing a desired level of IP protection (e.g. EIC standard 60529). Additionally, SLS 20 may include an additional motor, galvanometer, or similar device to rotate mirror 24 around a zenith or tilt axis 42. Sensors such as rotary encoders or other suitable devices may be used to measure the azimuth angle and zenith angle as SLS 20 scans each point in the area. The combination of rotation around pan axis 40 and rotation around tilt axis 42 allows the SLS 20 to scan a substantially entire volume in a 360 degree arc around SLS 20.

Base 30 may include one or more two-dimensional (2D) photographic cameras 32 capable of capturing a color photographic image. It should be appreciated that the cameras 32 are rotationally fixed relative to the body 22. Examples of possible camera models used as camera 32 may include, but are not limited to, model MC124CG-SY (12.4 megapixel) manufactured by XIMEA Corp., model CB500CG-CM (47.5 megapixel) manufactured by XIMEA Corp., or model axA4024-29uc (12 megapixel) manufactured by Basler AG. It will be understood that other manufacturers or models may be used for camera 32. Additionally, in at least an embodiment, camera 32 may be a global shutter camera. It should be appreciated that while embodiments herein refer to a “photographic” camera, this may be any suitable image sensor and associated optical assembly configured to acquire digital images within the field of view.

In an exemplary embodiment in which more than one camera 32 is included, the cameras 32 may be spread out in a plane perpendicular to the pan axis 40 of SLS 20. For example, cameras 32 may be arranged spaced apart in a circumferential direction around an outer edge of base 30 (see FIG. 20, for example). It will be noted that it is not necessary for the fields of view of cameras 32 to overlap. However, in at least an embodiment, fields of view of cameras 32 may overlap. In an exemplary embodiment, a field of view of camera 32 may be 85 degrees in a vertical direction (e.g. a direction perpendicular to the surface the device 10 is placed) and 56 degrees in a horizontal direction (e.g. a direction generally parallel with the surface the device 10 is placed). However, it will be understood that other fields of view may be used based at least in part on the geometry of 3D measurement device 10.

In an exemplary embodiment, cameras 32 may be positioned and oriented so that SLS 20 is not visible in the captured photographic images. Additionally, cameras 32 (and/or their lenses) may be of a sufficiently small size so as to not block the laser beam of SLS 20 as a scan area is scanned. In situations where the floor is of low interest to the operator, some blocking of SLS 20 by cameras 32 may be acceptable.

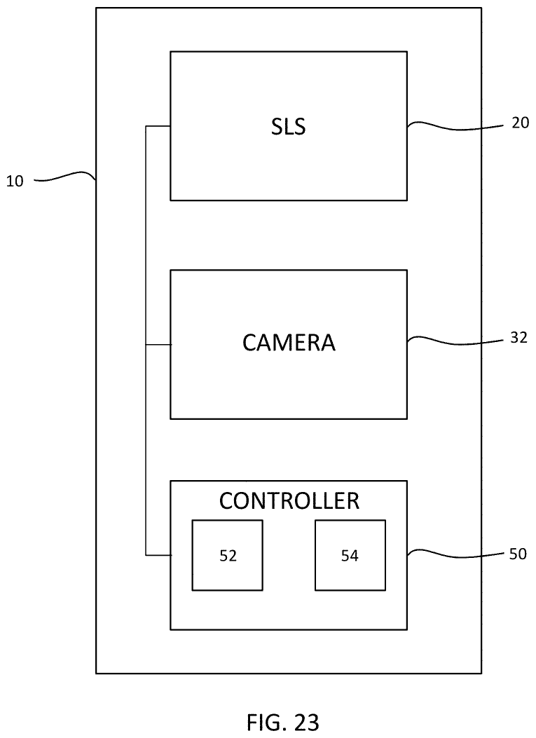

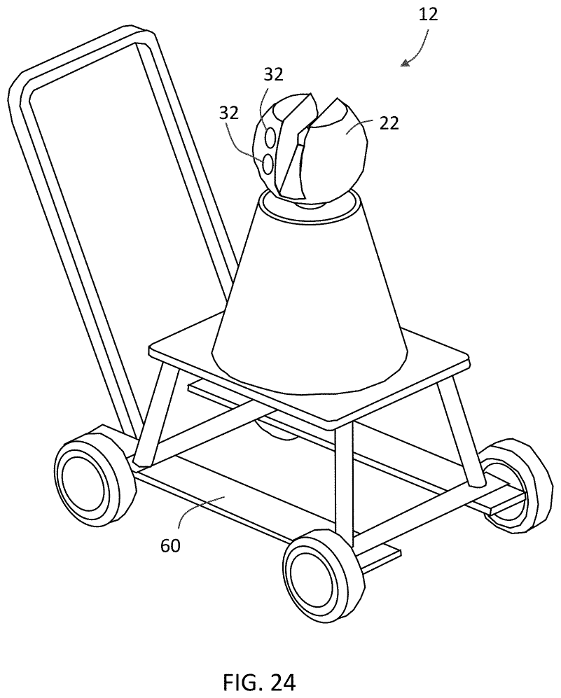

Scanning device 10 may further include a controller 50 that includes a processor 52 and a memory 54 (FIG. 23). Controller 50 may be operably connected to camera 32 and SLS 20 through wiring, a bus, or other suitable structure. Alternatively, controller 50 may be operably connected to camera 32 and SLS through wireless communication. In an exemplary embodiment, the connection between controller 50 and cameras 32 should be of sufficient speed to allow for capturing full resolution images from all cameras 32 with a frame rate of at least 0.5 Hz to 1 Hz. Additionally, controller 50 may be configured to handle the triggering of cameras 30. For example, controller 50 may pass a trigger from SLS 20 to all cameras 32 so that synchronization of all photographic images with the SLS 20 and its position are determined and stored. As an alternative, an intermediate controller may be provided for cameras 32 which triggers, gathers, processes and stores the recorded images. In this configuration, controller 50 would not communicate directly with cameras 32, but would instead communicate with the intermediate controller.

Controller 50 may be configured to control the operation of SLS 20. For example, controller 50 may control rotation of scanner body 22 around pan axis 40 and the rotation of mirror 24 around tilt axis 42. Additionally, controller 50 may receive information such as pan angle, title angle, and distance to surface and/or time of flight information, and processor 52 may use this information to calculate a 3D coordinate of the scanned point. The 3D coordinate may be stored in memory 54 along with 3D coordinates of other points to generated a 3D point cloud of the area being scanned. Scan points may also be associated with identifying information such as timestamp or location of the SLS 20 within the coordinate system to facilitate integration with scans taken at other locations or with color photographic images captured by cameras 32.

Controller 50 may also be configured control operation of cameras 32. For example, controller 50 may operate cameras 32 to capture a color photographic image, which may be stored in memory 54. The stored color photographic images may also be associated with identifying information such as timestamp or location of the SLS within the coordinate system to facilitate integration of the photographs with scan data.

Controller 50 may also be configured to add color data to the 3D point cloud captured by SLS 20 based on the color photographic images captured by cameras 32. For example, because the 3D coordinates of each point of the 3D point cloud in a fixed coordinate system is known, and because the position and orientation of cameras 32 relative to SLS 20 is fixed and known, controller 50 can assign coordinates to the captured photographic images within the coordinate system of the 3D point cloud captured by SLS 20. In other words, in an exemplary embodiment, SLS 20 may be recording a point cloud while being pushed on a small cart, mobile platform, or carrier (see FIG. 5, for example). Hence, because the position and orientation of the cameras 32 relative to SLS 20 are fixed and known, and because the position and orientation of the SLS 20 at the time of triggering the cameras is known, controller 50 can assign coordinates and orientation to the captured images within the coordinate system of the 3D point cloud. Controller 50 can then project points of the 3D point cloud to pixels of the captured photographic image. Then, controller 50 may attribute a color from each pixel of the captured photographic image to the corresponding point of the 3D point cloud that is projected to the pixel. The addition of color information to the 3D point cloud may be performed in post-processing.

As described herein, in at least an embodiment, controller 50 may control the camera to capture a plurality of sequential images, and each of the plurality of sequential images may overlap with temporally adjacent sequential images. Using photogrammetric principles, controller 50 may use these overlapping images to generate an image-based 3D point cloud. Subsequently, controller 50 may match points of the 3D point cloud generated by SLS 20 to points of the image-based 3D point cloud. Controller 50 may then attribute color data from the points in the image-based 3D point cloud to corresponding points in the 3D point cloud generated by SLS 20. Additionally, controller 50 may use a feature matching algorithm to fine tune the position and orientation of a camera within the point cloud based on identified features. Color information can be transferred at the position of the identified features.

FIG. 24 shows another exemplary embodiment of a scanning device 12 in which one or more cameras 32 may be provided on scanner body 22 instead of being provided on a separate base. In the embodiment of FIG. 24, camera 32 is fixed to the scanner body such that the camera rotates with the scanner body around the pan axis 40. Controller 50 may control camera 32 to capture a plurality of photographic images at a set time interval as SLS 20 scans the area and generates a 3D point cloud. Alternatively, controller 50 may control camera 32 to continuously capture photographic images as a video sequence. In an exemplary embodiment, the rate of capturing photographic images may be 1 image per second. It will be understood, however, that this rate is exemplary and the capture rate may be varied according to the specific needs of the scan job being performed.

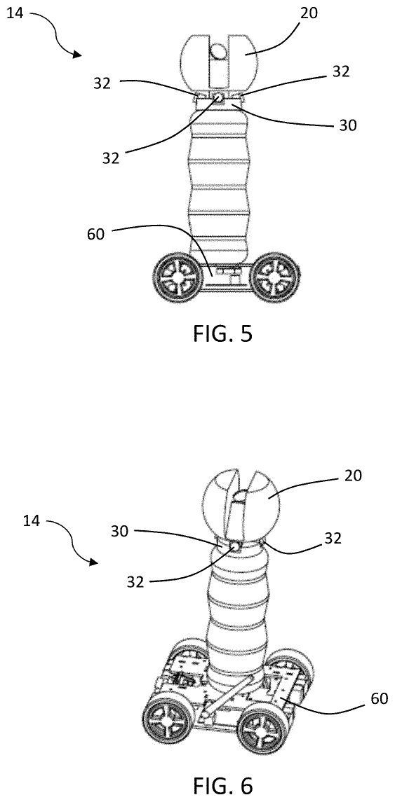

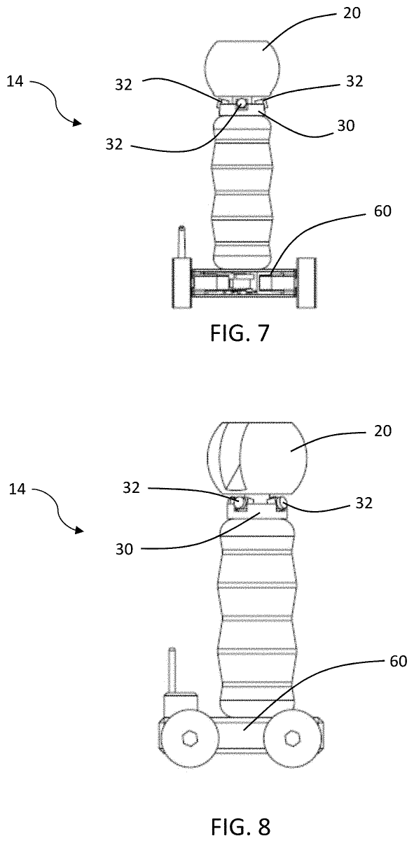

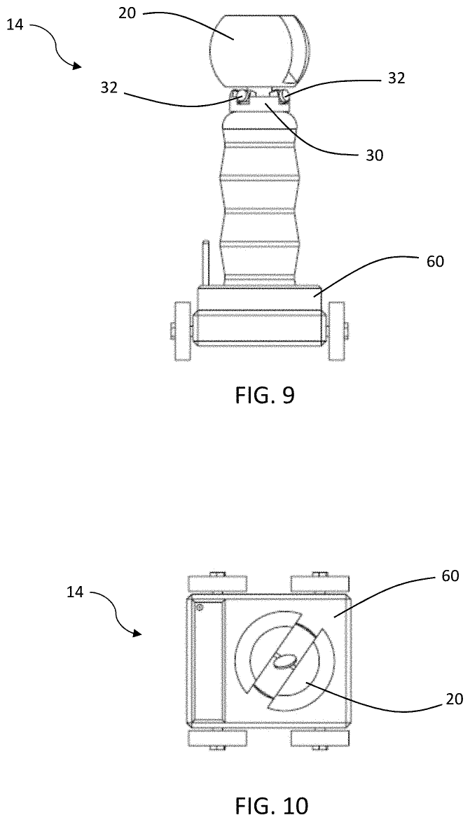

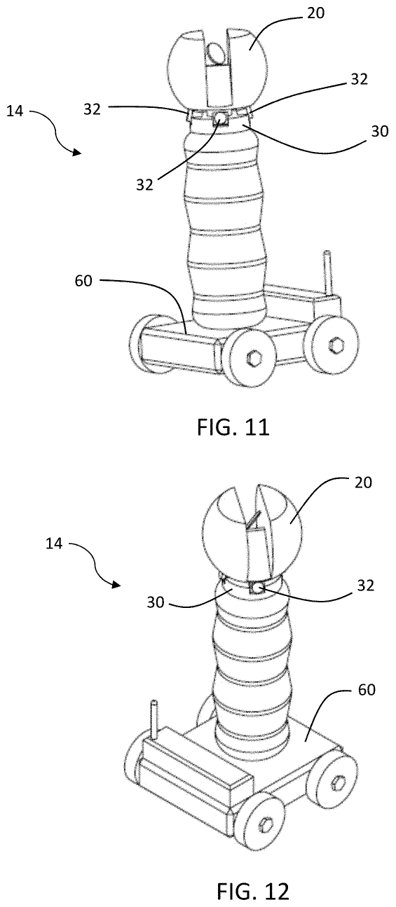

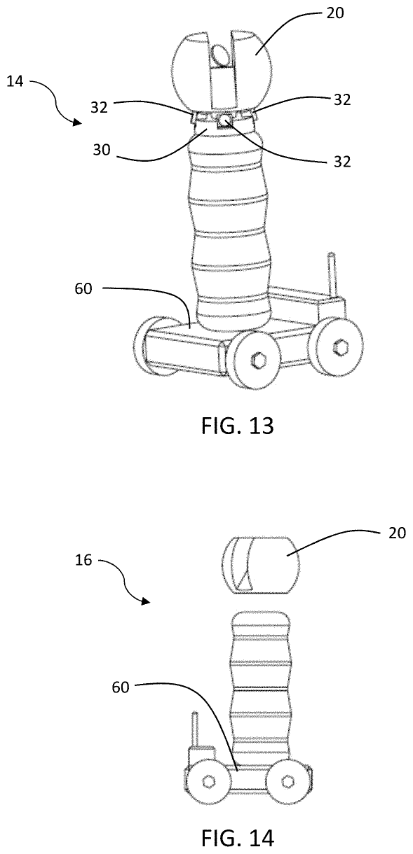

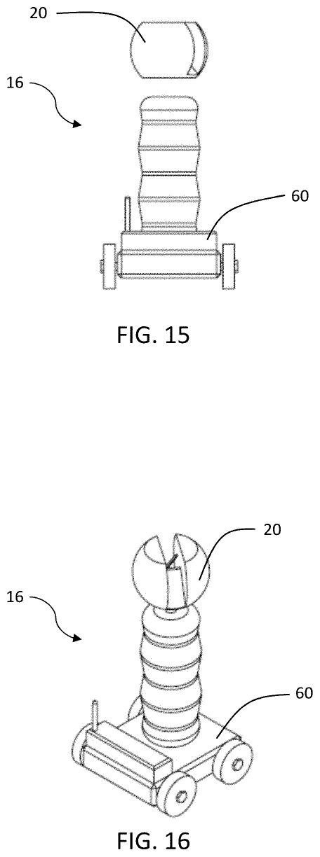

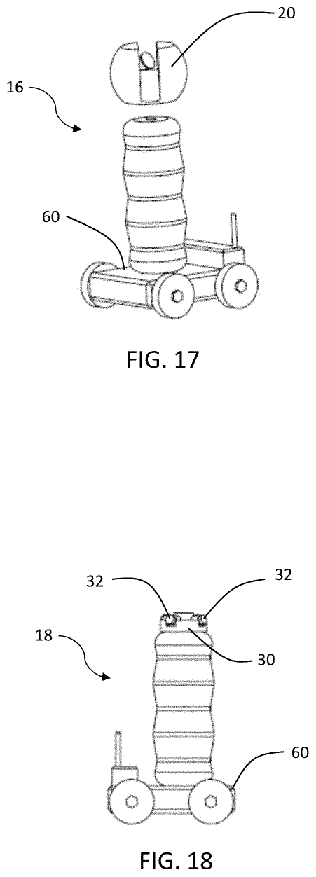

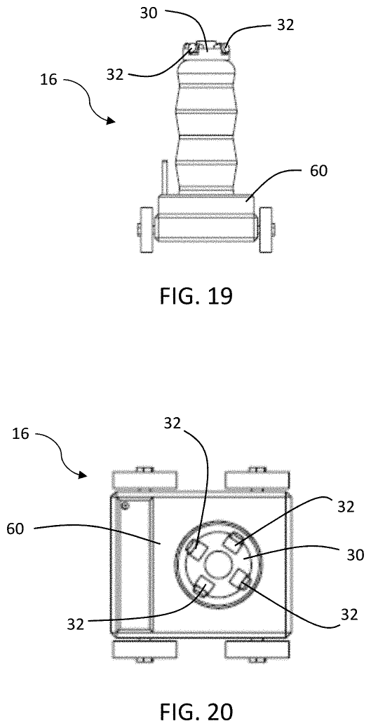

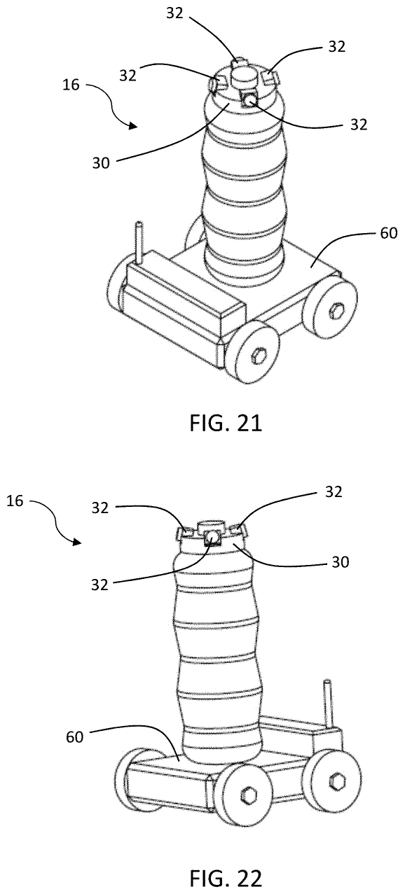

As seen in FIGS. 4-22 and FIG. 24, SLS 20 and base 30 may be provided on a carrier 60. Carrier 60 may be structured to move throughout the scan area. Carrier 60 may move due to force from a user, such as by being pushed or pulled. Alternatively, carrier 60 may be motorized and configured to follow a predetermined or pseudorandom path in an automated or semi-automated manner. Alternatively, carrier 60 may be motorized and controlled by a user remotely via wired or wireless communication.

When scanning device 10 or scanning device 12 is provided on carrier 60, controller 50 may be configured to control the camera to capture a plurality of photographic images at a predetermined fixed distance interval as the SLS and the camera move through the scan area. For example, controller 50 may control camera 32 to take a photographic image for every 1 meter travelled by carrier 60. It will be understood, however, that the 1 meter interval is exemplary only and the capture interval may be varied according to the specific needs of the scan job being performed. Further, it should be appreciated that in other embodiments, the triggering of the acquisition of images may be based on another parameter, such as the acquisition of a predetermined number of data points by the SLS 20 for example.

In order to determine the position of SLS 20 and camera(s) 32 as carrier 60 moves through the scan area, SLS 20 and controller 50 may perform simultaneous localization and mapping methodology to determine a position of SLS 20 within the coordinate system. Because the position and orientation of cameras 32 relative to SLS 20 are known, the position of SLS 20 determined by the simultaneous localization and mapping calculation can be used to determine the position of cameras 32 when the photographic images are captured. Additionally, cameras 32 may also be used for tracking, either in real-time during the scanning or as a refinement step in post processing. In some embodiments, the device 10 may include additional sensors, such as an inertial measurement unit or encoders on the wheels of the carrier 60 for example. The data from these additional sensors may be fused with the photographic images to localize the carrier 60 and SLS 20 within the environment. Controller 50 may also use interpolation methods to add points to the 3D point cloud in post-processing. In an exemplary embodiment, camera 32 may have a higher resolution than the 3D point cloud acquired by SLS 20. In this case, the captured photographic images may be used to assist in the interpolation to add points to the 3D point cloud.

In at least an embodiment, for a desired surface texture completeness, the 3D point cloud generated by SLS 20 may be triangulated into a mesh. The mesh may be a local mesh, i.e., per scanned room or per object in the room, or alternatively. The full resolution texture may be attached to the mesh.

In at least an embodiment, controller 50 may calculate a virtual panoramic image based on the 3D point cloud with the associated color data from the captured photographic images. The panoramic image may be based on the mesh or the interpolated point cloud. For example, controller 50 may choose a position and orientation in 3D. Controller 50 may calculate a two-dimensional (2D) angle to each 3D point visible from the position and orientation, and the color information may be used to color a pixel in a synthetic epirectangular image (i.e., an image which spans 360 degrees horizontally and 180 degrees vertically). Holes in the image may be filled in with color information from the raw photographic images. For example, based on known 3D points and the corresponding pixel position in the raw photographic image, the homography between the raw photographic image and the virtual panoramic position can be calculated by controller 50. This may be calculated in a specific region of interest (ROI). The raw photographic image (or the relevant ROI) may be transformed based on the retrieved homography and warped according to its position in the epirectangular image. The resulting patch may be used to color pixels in the panoramic image.

It will be understood the scanning of points, capturing of images, and processing and storage of the data may consume a large amount of resources of scanning device 10. In order to reduce the resource requirements in at least an embodiment of scanning device 10, camera 32 may be switchable between a first resolution and a second resolution, the first resolution may be higher than the second resolution. Controller 50 may be configured to control camera 32 to capture a plurality of low resolution images at the second resolution. Controller 50 may be further configured to evaluate each low resolution image of the plurality of low resolution images as it is captured by the camera. Controller 50 may be further configured to, in response to a low resolution image of the plurality of low resolution images satisfying a predetermined condition, control the camera to capture a high resolution image at the first resolution. At least an embodiment of the predetermined condition will be described in further detail herein. The captured high resolution image may be used by controller 50 as the color photographic image used to add color data to the 3D point cloud.

In an exemplary embodiment in which multiple cameras 32 with variable resolution are provided, controller 50 may be configured to independently evaluate the predetermined condition for each of the multiple cameras 32. Further, controller 50 can control each camera 32 to capture a high resolution image independently.

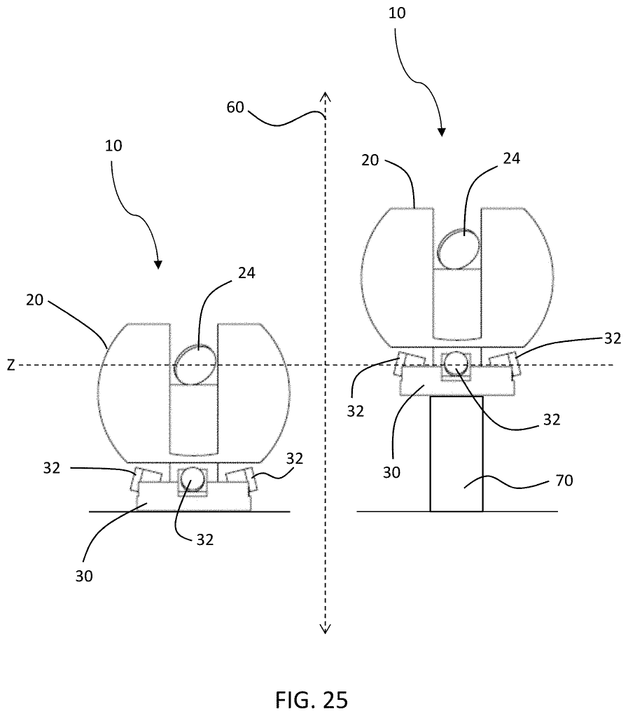

FIG. 25 shows an exemplary embodiment in which scanning device 10 may include a lift mechanism 70 structured to move base 30 and SLS 20 in a first direction 70, which is parallel to pan axis 40 of SLS 20. Non-limiting examples of lift mechanism 70 may include a piston, a linear actuator, a rack and pinion assembly, or scissor lift. Lift mechanism 70 may be operably coupled to controller 50. When SLS 20 is scanning the area, an optical axis of SLS 20 intersects pan axis 40 at a first coordinate Z in the first direction. Once the 3D point cloud is captured, controller 50 may control lift mechanism 70 to raise base 30 until an optical axis of cameras 32 intersects the pan axis at the first coordinate Z, at which point controller 50 controls cameras to capture a photographic image. In other words, the photographic images are captured when an optical axis of cameras 32 are at a same vertical height of an optical axis of SLS 20 when the area is scanned. The adjustment of the height of cameras 30 helps to reduce parallax between the captured photographic images and the 3D point cloud.

In at least an embodiment, the predetermined condition evaluated by controller 50 may include detection of one or more features in the low resolution photographic images. The feature detection may be any known feature detector, such as by not limited to SIFT, SURF and BRIEF methods. Regardless of the feature detection process used, one or more features (edges, corners, interest points, blobs or ridges) may be identified in the low resolution images. In at least an embodiment, controller 50 may evaluate the difference in identified features in subsequent low resolution images. The evaluation may be performed using a FLANN feature matching algorithm or other suitable feature matching algorithm. In at least an embodiment, controller 50 may determine to capture a high resolution image when the difference in identified features between low resolution images is greater than a predetermined amount. In other words, when controller 50 is controlling camera 32 to capture images at a predetermined frequency or distance interval, there may be little substantive difference between sequential photographic images, and it may unduly burden the resources of scanning device 10 to process and store photographic images that are substantially similar. Accordingly, by utilizing low resolution images and evaluating differences between the images, controller 50 can determine to capture a high resolution image only when there is sufficient difference to make the capture worthwhile. Thus, resource consumption of scanning device 10 can be managed.

FIGS. 4-13 show an exemplary embodiment of a 3D measurement device 14. 3D measurement device 14 shows SLS 20, a base 30 on which a plurality of cameras 32 are mounted, and carrier 60. FIGS. 14-17 show an exemplary embodiment of a 3D measurement device 16 in which only SLS 20 is mounted on carrier 60. FIGS. 18-22 show an exemplary embodiment of a 3D measurement device 18 in which base 30 with a plurality of cameras 32 mounted on carrier 60. 3D measurement device 18 may be operated on its own, or alternatively base 30 may be structured to receive and mount an SLS.

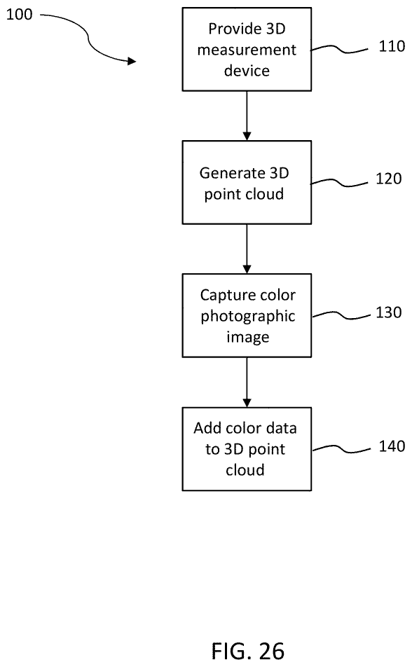

FIG. 26 shows an exemplary embodiment of a method 100 for measuring 3D data of an area or environment. In block 110, a scanning device 10 including an SLS 20, a camera 32, and a controller 50 is provided. In block 120, a 3D point cloud of an area is generated by the SLS 20, which is stored in a memory 54 of the controller 50. The generation of the 3D point cloud may include rotating the SLS 20 around a pan axis 40 of the SLS 20 and rotating a mirror 24 of the SLS 20 around a tilt axis 42. In block 130, a color photographic image of the area is captured with the camera 32 and stored in the memory 54 of the controller 50. In block 140, the controller 50 adds color data from the color photographic image to the 3D point cloud.

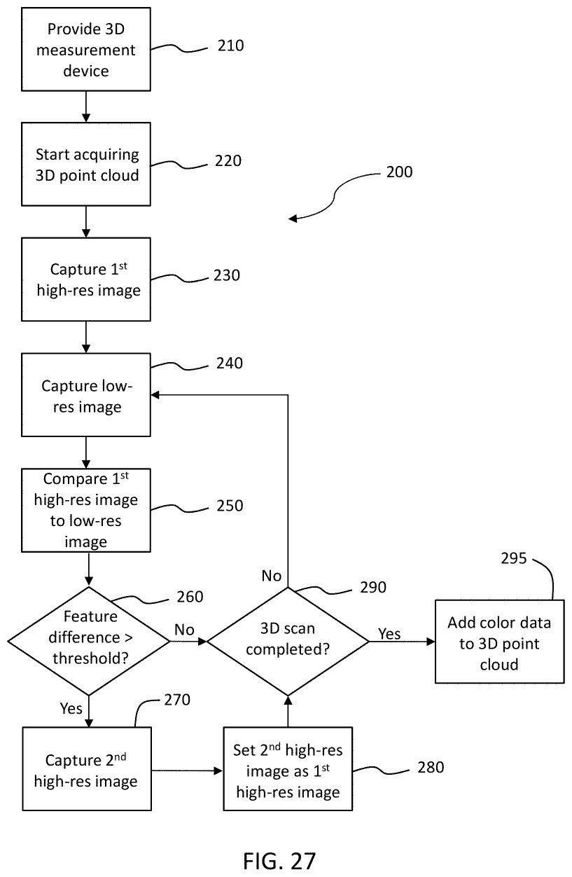

FIG. 27 shows another exemplary embodiment of a method 200 for measuring 3D data of an area or environment. In block 210, a scanning device 10 including an SLS 20, a camera 32, and a controller 50 is provided. In block 220, the SLS 20 begins acquiring a 3D point cloud of the scan area. In block 230, the camera 32 captures a first high resolution image and stores it in memory 54 of controller 50. In block 240, the camera 32 captures a low resolution image. In block 250, the first high resolution image is compared to the low res-image. For example, feature identification algorithms may be used to identify corresponding features in the first high resolution image and low resolution image and quantify an amount of difference between corresponding features. In block 260, it is determined whether the difference in features between the first high resolution image and the low resolution is greater than a predetermined threshold. Once the feature difference is greater than the predetermined threshold (i.e., “yes” in block 270), a second high resolution image is captured in block 270 by camera 32 and saved in memory 54. The “feature difference” could also be determined by a number of features from a first image being no longer visible in a second image. In block 280, the second high resolution image is set as the first high resolution image before proceeding to block 290. In other words, the second high resolution image becomes the basis for comparison to subsequent low resolution images. In block 290, it is determined whether the SLS 20 has completed the 3D scan of the scan area. If the scan is not completed (i.e., “no” in block 290), then the method returns to block 240 and another low resolution image is captured by camera 32. If the scan is completed (i.e., “yes” in block 290), the method proceeds to block 295 where the high resolution images are used to add color data to the 3D point cloud.

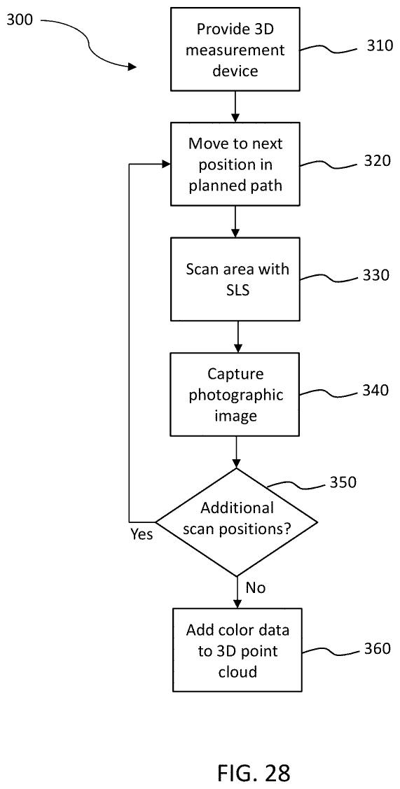

FIG. 28 shows another exemplary embodiment of a method for measuring 3D data of an area of environment. In block 310, a scanning device 10 including an SLS 20, a camera 32, and a controller 50 is provided, the scanning device 10 being mounted on a movable carrier 60. The movable carrier 60 may have a planned path programmed into controller 50, or, alternatively, the movable carrier 60 may be hand moved by a user along a predetermined path. In block 320, the carrier 60 is moved to the next position in the planned path. In block 330, SLS 20 performs a scan of the scan area and stores the data in a memory 54 of controller 50. In block 340, camera 32 captures a photographic image and stores it in memory 54. In block 350, it is determined whether there are additional scan positions in the planned path. If there are additional scan positions (i.e., “yes” in block 350), the method returns to block 320 where the carrier 60 is moved to the next position in the planned path. If there are no additional scan positions in the planned path (i.e., “no” in block 350), the method proceeds to block 360, where processor 50 adds color data from the photographic images to the 3D point cloud.

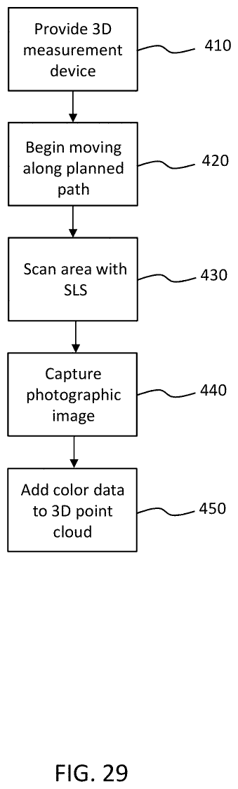

FIG. 29 shows another exemplary embodiment of a method for measuring 3D data of an area or environment. Whereas FIG. 28 illustrates a method with discrete scan positions, FIG. 29 illustrates a method in which the SLS scans continuously while moving. In block 410, a scanning device 10 including an SLS 20, a camera 32, and a controller 50 is provided, the scanning device 10 being mounted on a movable carrier 60. The movable carrier 60 may have a planned path programmed into controller 50, or, alternatively, the movable carrier 60 may be hand moved by a user along a predetermined path. In block 420, the movable carrier 60 begins moving along the planned path. In block 430, SLS 20 performs a scan of the scan area while carrier 60 moves along the planned path and stores the data in a memory 54 of controller 50. In block 440, camera 32 captures a photographic image and stores it in memory 54 at a predetermined interval. The predetermined interval can be based on time, distance traversed by carrier 60, or based on feature differences as described in detail above. In block 450, processor 50 adds color data from the photographic images to the 3D point cloud. While FIG. 29 describes an embodiment in which the carrier 60 is continuously moved while scanning, it will be noted that the method can incorporate short pauses at intermediate positions in order to increase the density of points being recorded at the intermediate position. 3D data from these pauses may be used to assist in correction of the path estimation of the SLS 20.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “unit,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the laser scanner, partly on the laser scanner, as a stand-alone software package, partly on the laser scanner and partly a connected computer, partly on the laser scanner and partly on a remote computer or entirely on the remote computer or server. In the latter scenario, the remote computer may be connected to the laser scanner through any type of network, including a local area network (LAN) or a wide area network (WAN), or the connection may be made to an external laser scanner (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, may be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the FIGS. 23 and 26-29 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the FIGS. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A three-dimensional (3D) measuring device comprising:
a spherical laser scanner (SLS) structured to generate a 3D point cloud of an area;
a plurality of cameras, each camera of the plurality of cameras being structured to capture a color photographic image;
a controller operably coupled to the SLS and the camera; and
a base on which the plurality of cameras are fixedly mounted and on which the SLS is rotationally mounted;
wherein the controller comprises a processor and a memory;
wherein the controller is configured to add color data to the 3D point cloud based on the color photographic images captured by the plurality of cameras;
wherein the plurality of cameras is provided on the base and spaced apart in a circumferential direction around a pan axis of the SLS;
the plurality of cameras is fixed relative to the pan axis.

2. The scanning device of claim 1, wherein the controller is configured to control the plurality of cameras to capture a plurality of color photographic images at a fixed time interval.

3. The scanning device of claim 1, wherein the SLS and the plurality of cameras are provided on a movable carrier.

4. The scanning device of claim 3, wherein the controller is configured to control the plurality of cameras to capture a plurality of color photographic images at a fixed distance interval as the SLS and the camera move through the area.

5. The scanning device of claim 1, wherein a resolution of a first camera of the plurality of cameras is switchable between a first resolution and a second resolution, the first resolution being higher than the second resolution;
wherein the controller is configured to control the first camera to capture a plurality of low resolution images at the second resolution;
wherein the controller is configured to evaluate each low resolution image of the plurality of low resolution images as it is captured by the first camera;
wherein the controller is configured to, in response to a low resolution image of the plurality of low resolution images satisfying a predetermined condition, control the first camera to capture a high resolution image at the first resolution; and
wherein the controller is configured to add color data to the 3D point cloud based on the high resolution image.

6. The scanning device of claim 5,
wherein a resolution of each camera of the plurality of cameras is switchable between the first resolution and the second resolution; and
the controller is configured to independently determine for each camera of the plurality of cameras when to capture a high resolution image.

7. The scanning device of claim 1, wherein the controller is configured to add color data to the 3D point cloud by:
projecting points of the 3D point cloud to pixels of the color photographic image based on a position and orientation of the camera relative to the SLS; and
attributing a color from each pixel of the color photographic image to a corresponding point of the 3D point cloud.

8. The scanning device of the claim 1, wherein the controller is configured to control the plurality of cameras to capture a plurality of sequential images;
wherein temporally adjacent sequential images of the plurality of sequential images capture a substantially same scenery from different perspectives;
wherein the controller is configured to photogrammetrically generate an image-based 3D point cloud based on the plurality of sequential images; and
the controller is configured to add color data to the 3D point cloud by:
matching points of the 3D point cloud generated by the SLS to points of the image-based 3D point cloud; and
attributing a color from each point of the image-based 3D point cloud to a corresponding point of the 3D point cloud.

9. The scanning device of claim 1, further comprising a drive structured to move the plurality of cameras in a first direction parallel with a pan axis of the SLS, the drive being operably coupled to the controller;
wherein an optical axis of the SLS intersects the pan axis at a first coordinate in the first direction while generating the 3D point cloud;
wherein the controller is configured to control the drive to move the plurality of cameras in the first direction such that optical axes of the plurality of cameras intersect the pan axis at the first coordinate in the first direction; and
wherein the controller is configured to control the plurality of cameras to capture the color photographic image while the optical axes of the plurality of cameras intersect the pan axis at the first coordinate in the first direction.

10. A base for use with a spherical laser scanner (SLS) structured to generate a 3D point cloud, the base comprising:
a base body structured to mount the spherical laser scanner;
a plurality of cameras fixedly mounted on base body spaced in a circumferential direction around a pan axis of the SLS, each of the plurality of cameras being structured to capture a color photographic image;
a controller operably coupled to the SLS and the plurality of cameras;
wherein the controller comprises a processor and a memory; and
wherein the controller is configured to add color data to the 3D point cloud based on color photographic images captured by the plurality of cameras.

11. A method for measuring three-dimensional (3D) data of an area, the method comprising:
generating, with a spherical laser scanner (SLS), a 3D point cloud of an environment, the SLS being rotationally mounted to a based;
capturing, with a plurality of cameras, color photographic images of the environment, the plurality of cameras being mounted on the base and spaced apart in a circumferential direction around a pan axis of the SLS; and
adding color data to the 3D point cloud based on the color photographic images.

12. The method of claim 11, wherein the capturing the color photographic images comprises capturing a plurality of color photographic images at a fixed time interval.

13. The method of claim 11, wherein a resolution of a first camera of the plurality of cameras is switchable between a first resolution and a second resolution, the first resolution being higher than the second resolution;
wherein the capturing the color photographic images comprises:
capturing a plurality of low resolution images at the second resolution with the first camera;
evaluating each low resolution image of the plurality of low resolution images as it is captured by the first camera; and
in response a low resolution image of the plurality of low resolution images satisfying a predetermined condition, capturing, with the first camera, a high resolution image at the first resolution as the color photographic image.

14. The method of claim 13, wherein each camera of the plurality of cameras switchable between the first resolution and the second resolution; and
the capturing the color photographic images further comprises independently determining for each of the plurality of cameras when to capture a high resolution image.

15. The method of claim 11, wherein the adding color data to the 3D point cloud based on the color photographic image comprises:
projecting points of the 3D point cloud to pixels of the color photographic image based on a position and orientation of the camera relative to the SLS; and
attributing a color from each pixel of the color photographic image to a corresponding point of the 3D point cloud.

16. The method of claim 11, wherein the capturing the color photographic images comprises capturing a plurality of sequential images;
wherein temporally adjacent sequential images of the plurality of sequential images capture a substantially same scenery from different perspective;
the method further comprises photogrammetrically generating an image-based 3D point cloud based on the plurality of sequential images; and
the adding color data to the 3D point cloud based on the color photographic image comprises:
matching points of the 3D point cloud generated by the SLS to points of the image-based 3D point cloud; and
attributing a color from each point of the image-based 3D point cloud to a corresponding point of the 3D point cloud.

17. The method of claim 11, wherein, during the generating the 3D point cloud, an optical axis of the SLS intersects a pan axis of the SLS at a first coordinate in a first direction parallel with the pan axis;
the capturing a color photographic image comprises:
moving the plurality of cameras in the first direction until optical axes of the plurality of cameras intersect the pan axis at the first coordinate in the first direction;
capturing the color photographic images while the optical axes of the plurality of cameras intersect the pan axis at the first coordinate in the first direction.

18. A method for measuring three-dimensional (3D) data of an area, the method comprising:
providing a spherical laser scanner (SLS) and a camera mounted on a moveable carrier;
moving the carrier along a movement path within the area;
while the carrier is being moved along the movement path, generating, with the SLS, a 3D point cloud of the area;
capturing, with the camera, a plurality of color photographic images at a predetermined distance interval along the movement path;
adding color data to each of the 3D point clouds based on the plurality of color photographic images.
